(19) United States
(12) Patent Application Publication
(10) Pub. No.: US 2014/0059491 A1
(43) Pub. Date: Feb. 27, 2014

(54) ELECTRONIC APPARATUS TO EXECUTE APPLICATION, METHOD THEREOF, AND COMPUTER READABLE RECORDING MEDIUM

(71) Applicant: SAMSUNG ELECTRONICS CO., LTD., Suwon-si (KR)

(72) Inventors: Su-yong KIM, Yongin-si (KR); Jun-seok PARK, Seoul (KR); Ha-ryun LEE, Yongin-si (KR); Sang-jun HONG, Seoul (KR)

(73) Assignee: SAMSUNG Electronics Co., Ltd., Suwon-si (KR)

(21) Appl. No.: 13/875,336

(22) Filed: May 2, 2013

(30) Foreign Application Priority Data
Aug. 24, 2012 (KR) 10-2012-0092992

(51) Int. Cl. G06F 3/0481; G06F 3/0482

(52) U.S. Cl. CPC G06F 3/04817; G06F 3/0482
USPC 715/835

(57) ABSTRACT

An electronic apparatus includes a storage which stores a plurality of applications, a manager which manages a first list regarding a desktop application from among the plurality of applications stored in the storage, and manages a second list regarding a desktop application that has been already selected from among the desktop applications, a user interface which displays a first icon which corresponds to the first list and a second icon which corresponds to each desktop application included in the second list, and a controller which, if one of the displayed second icons is selected, drives a desktop application corresponding to the selected icon.

### CROSS-REFERENCE TO RELATED APPLICATIONS

This application claims priority under 35 U.S.C. §119 from Korean Patent Application No. 10-2012-0092992, filed on Aug. 24, 2012, in the Korean Intellectual Property Office, the disclosure of which is incorporated herein by reference in its entirety.

### BACKGROUND OF THE INVENTION

1. Field of the Invention

Methods and apparatuses consistent with exemplary embodiments relate to an electronic apparatus, a method for executing an application, and a computer readable recording medium, and more particularly, to an electronic apparatus which can easily execute a desktop application, a method for executing an application, and a computer readable recording medium.

2. Description of the Related Art

Computers, which are apparatuses that process a series of calculations implemented in a logic language, are equipped with an operating system to operate a hardware system efficiently.

A modern operating system provides a plurality of operating environments for the sake of easy manipulation in a mobile environment as well as a desktop environment. Specifically, the modern operating system may support not only a desktop mode such as an existing PC environment, but also a touch screen-based metro mode, which is provided by a related-art mobile phone or the like. Therefore, applications executable in the desktop mode and applications executable in the metro mode are installed together in the modern operating system.

However, since such a modern operating system does not separately display the installed applications according to the driving mode, it is not easy to select an application from among the great number of applications installed.

Specifically, most of the offices use the desktop mode rather than the metro mode. In this case, it is easier to select a desired application from among the applications executable in the desktop mode than to select it from among all of the applications installed in the computer. However, since the modern operating system does not separately the installed applications according to the driving mode as described above, it is difficult for a user to select an application executable in the desktop mode.

### SUMMARY OF THE INVENTION

The present general inventive concept provides an electronic apparatus which can easily execute a desktop application, a method of executing an application, and a computer readable recording medium.

Additional features and utilities of the present general inventive concept will be set forth in part in the description which follows and, in part, will be obvious from the description, or may be learned by practice of the general inventive concept.

The foregoing and other features and utilities of the present general inventive concept may be achieved by providing an electronic apparatus including a storage which stores a plurality of applications, a manager which manages a first list regarding a desktop application from among the plurality of applications stored in the storage, and manages a second list regarding a desktop application that has been already selected from among the desktop applications, a user interface which displays a first icon which corresponds to the first list and a second icon which corresponds to each desktop application included in the second list, and a controller which, if one of the displayed first and second icons is selected, drives a desktop application corresponding to the selected icon.

The manager may classify the plurality of applications stored in the storage into a desktop application and a metro application according to whether the application includes a unique ID value or not, and may manage an application which is classified as a desktop application as the first list.

The manager may manage an application which is stored in a pre-set folder from among the plurality of applications stored in the storage as the first list.

The user interface may arrange and display the second icon based on at least one of an installing time and a frequency of execution of a desktop application corresponding to the second icon.

The user interface may arrange and display the second icon corresponding to each desktop application included in the list based on at least one of an installing time and a frequency of execution.

If a mouse pointer is placed on one of the plurality of icons, the user interface may change a size of the icon on which the mouse pointer is placed and display the icon.

If the displayed first icon is selected, the user interface may display the first list.

If one desktop application is selected from the displayed first list, the controller may drive the selected desktop application.

If one desktop application is selected from the displayed first list, the manager may add the selected desktop application to the second list.

If the displayed first icon is selected, the user interface may arrange and display the plurality of desktop applications included in the first list based on at least one of an installing time, whether the desktop application is included in the second list or not, and a frequency of execution.

The manager may group the already selected desktop applications according to a predetermined category, and the user interface may display a third icon corresponding to the grouped desktop applications along with the first icon and the second icon.

If a mouse pointer is placed on the third icon, the user interface may display a plurality of second icons corresponding to the third icon in sequence.

If the number of desktop applications included in the second list is greater than a predetermined number, the manager may group the already selected desktop applications according to the predetermined category.

When a mouse pointer is placed on a predetermined location, the controller may control the user interface to display the first icon and the second icon on a predetermined location.

The foregoing and other features and utilities of the present general inventive concept may also be achieved by providing a method of executing an application, the method including managing a first list regarding a desktop application from among a plurality of pre-stored applications, and managing a second list regarding a desktop application that has been already selected from among the desktop applications, displaying a first icon which corresponds to the first list and a second icon which corresponds to each desktop application included in the second list, selecting one of the displayed second icons, and driving a desktop application corresponding to the selected icon.

The managing may include classifying the plurality of applications stored in a storage into a desktop application and a metro application according to whether the application includes a unique ID value or not, and managing an application which is classified as a desktop application as the first list.

The managing may include managing an application which is stored in a pre-set folder from among the plurality of applications stored in the storage as the first list.

The method may further include, if the displayed first icon is selected, displaying the first list.

The managing may include grouping the already selected desktop applications according to a predetermined category, and the displaying may include displaying a third icon corresponding to the grouped desktop applications along with the first icon and the second icon.

The displaying may include, if a mouse pointer is placed on the third icon, displaying a plurality of second icons corresponding to the third icon in sequence.

The foregoing and other features and utilities of the present general inventive concept may also be achieved by providing a computer readable recording medium including a program to execute a method of executing an application, the method including managing a first list regarding a desktop application from among a plurality of pre-stored applications, and managing a second list regarding a desktop application that has been already selected from among the desktop applications, displaying a first icon which corresponds to the first list and a second icon which corresponds to each desktop application included in the second list, selecting one of the displayed second icons, and driving a desktop application corresponding to the selected icon.

The foregoing and other features and utilities of the present general inventive concept may also be achieved by providing an electronic apparatus, which has a first operation mode in which a desktop application is driven and a second operation mode in which a metro application is driven, and which includes a plurality of applications, the electronic apparatus including a manager to form a first list to include one or more desktop applications from among the plurality of applications, and to form a second list including one or more of the desktop applications that have been already selected from among the desktop applications; and a user interface having a screen to display a first icon which corresponds to the first list and one or more second icons which correspond to each desktop application included in the second list.

The manager may form a third icon corresponding to a third list including one or more of the one or more desktop applications of the second list which have a same category.

The manager may form a third icon corresponding to a third list including one or more of the one or more desktop applications of the second list, and the user interface displays the one or more desktop applications of the second list or the one or more desktop applications of the third list according to a priority.

The user interface may display the first icon and the second icon according to an input to select at least one of the first icon and the second icon, and prevent the first icon and the second icon from being displayed on the screen when an operating system is performed and displayed on the screen until the input.

The user interface may display the first icon and the second icon according to an operation of a QWERTY key board including a mouse with respect to the screen of the user interface.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an electronic apparatus according to an exemplary embodiment of the present general inventive concept;

FIG. 2 is a block diagram illustrating a controller of the electronic apparatus of FIG. 1;

FIGS. 3 to 8 are views illustrating various examples of a user interface window which may be displayed on a user interface of the electronic apparatus of FIG. 1;

FIG. 9 is a flowchart illustrating a method of executing an application according to an exemplary embodiment of the present general inventive concept;

FIG. 10 is a flowchart illustrating an operation of classifying applications in the method of FIG. 9 according to an embodiment of the present general inventive concept; and

FIG. 11 is a flowchart illustrating an operation of displaying in the method of FIG. 9 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

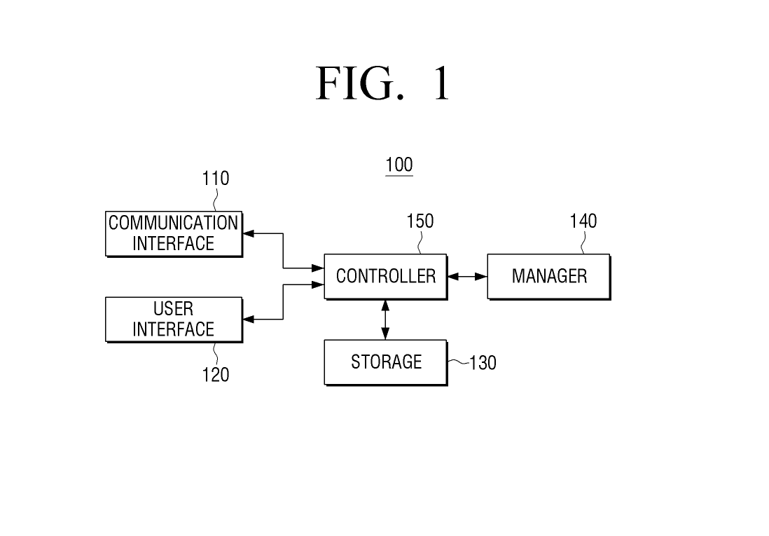

FIG. 1 is a block diagram illustrating an electronic apparatus 100 according to an exemplary embodiment of the present general inventive concept.

Referring to FIG. 1, the electronic apparatus 100 according to an exemplary embodiment includes a communication interface 110, a user interface 120, a storage 130, a manager 140, and a controller 150. The electronic apparatus 100 may be a personal computer (PC), a notebook computer, a tablet PC, a portable media player (PMP), or a mobile phone, in which an operating system having a first operation mode in which a desktop application is driven and a second operation mode in which a metro application is driven is driven. Such an operating system may be MICROSOFT's WINDOWS 8, for example. However, the present general inventive concept is not limited thereto. It is possible that other operating systems can be used as the operating system described above or below.

The desktop application refers to an application that is executed in a PC environment (that is, in a state suitable for an input environment which is based on a keyboard, for example, QWERTY key board, and a mouse). The metro application refers to an application that is executed in a mobile phone environment (that is, in a state suitable for an input environment which is based on a touch screen or a panel usable as an output/input unit).

The communication interface 110 is adapted to connect the electronic apparatus 100 to an external apparatus (not illustrated), and may access the external apparatus through a local area network (LAN) and the Internet or may access the external apparatus in a wireless communication method (for example, GSM, UMTS, LTD, WiBRO, and the like).

The communication interface 110 may receive an application from an external apparatus (not illustrated). The received application is installed in the electronic apparatus 100 under control of the controller 150 and is stored in a pre-set folder of the storage 130.

The user interface 120 may include a plurality of function keys through which a user sets or selects various functions supported by the electronic apparatus 100, and may display diverse information provided by the electronic apparatus 100. The user interface 120 may be realized by an apparatus that implements input and output simultaneously such as a touch screen, or may be realized by an apparatus combining a mouse and a monitor. The user interface 120 may include a touch screen and also may include a mouse and a monitor.

The user interface 120 may display a first icon corresponding to a first list and a second icon corresponding to a second list. The first list may include one or more desktop applications among a plurality of applications, and the second list may include one or more of the desktop applications which have been already used at least once among the one or more desktop applications of the first list. At this time, the user interface 120 may arrange and display the second icon based on at least one of an installing time and a frequency of execution of the one or more desktop applications included in the second list. The second icon may include a plurality of second icons if the desktop applications of the second list are grouped according to a category. And the user interface 120 may display a third icon including the one or more grouped second icons along with the first icon and the second icon.

The user interface 120 may include a display screen to include a region on which such a plurality of icons are displayed (hereinafter, referred to as a quick starter region) only if a mouse is activated or selected such that a mouse pointer is placed on a predetermined location of the display screen. For example, the quick starter region may be hidden from the screen thereof or from an image displayed on the screen when another job is performed thereon and may appear in the screen when the mouse pointer is placed on a lowermost portion (or an uppermost portion, a right end portion, or a left end portion) of a user interface window (screen) or when a predetermined portion of a desktop operating system is displayed or operated.

When the mouse pointer is placed on one of the plurality of icons, the user interface 120 may change a size of the icon on which the mouse pointer is placed and may display the icon. When the mouse pointer is placed on one of the first icon, the second icon, and the third icon, a size of the icon on which the mouse pointer is placed may be made larger than the other icons or the icon is bold or emphasized such that the icon may be displayed as a larger icon or a bold icon. It is possible that the size of the icon may be made smaller than the other icons. If the size of the icon is made larger than the other icons, a size of an adjacent icon may be smaller than the icon, but may be larger than a distal icon. The other icons may have a variable size or emphasized degree according to a distance from the icon such that a user can recognize the selected icon from the other icons.

If the mouse pointer is placed on the third icon, the user interface 120 may display the second icons corresponding to the third icon in sequence. For example, if three desktop applications are grouped into a first group, the third icon corresponding to the first group may be displayed on the quick starter region. At this time, if the user places the mouse pointer on the third icon, the user interface 120 may change the third icon to the second icons corresponding to the three desktop applications included in the first group and display the second icons in sequence at predetermined time intervals (for example, at intervals of 1 second).

If the third icon is selected from among the plurality of icons, the user interface 120 may display the second icon corresponding to each of the plurality of desktop applications corresponding to the third icon. At this time, the second icon may be displayed in the vicinity of the third icon (for example, above the third icon). If the mouse pointer moves away from the second icon and the third icon by more than a predetermined distance, the user interface 120 may stop displaying the second icon corresponding to the third icon.

If the first icon is selected from among the plurality of icons, the user interface 120 may display the first list corresponding to the first icon. At this time, the user interface 120 arranges and displays a plurality of desktop applications included in the first list based on at least one of an installing time, whether a desktop application is included in the second list or not, and a frequency of execution. The user may select a desktop application that a user wishes to execute using the displayed first list, and may install a shortcut icon of the selected desktop application on a desktop or may add the desktop application to the quick starter region described above.

The storage 130 stores a program to drive the electronic apparatus 100. The storage 130 may store a program which is a collection of various commands necessary to drive the electronic apparatus 100. The program includes an operating system and various applications. The operating system may be an operating program to drive the electronic apparatus 100 and may have a first operation mode in which the desktop application is driven and a second operation mode in which the metro application is driven.

The storage 130 stores the first list and the second list. The storage 130 may store the first list and the second list which are managed by the manager 140, which will be described later. The first list is a list that includes one or more desktop applications from among the plurality of applications stored in the storage 130. The second list is a list that includes one or more desktop applications which has been already selected (or used) by the user from among the desktop applications (that is, an application added to the quick starter region).

The storage 130 stores various icons. The storage unit 130 may store the first icon corresponding to the first list, the second icon corresponding to each of the desktop applications of the second list, and the third icon corresponding to a category.

The storage 130 may be realized by an internal storage medium and an external storage medium of the electronic apparatus 100, such as a USB memory, a removable disk including a flash memory, a storage medium connected to an image pickup apparatus, and a web server connected through a network.

The manager 140 manages the first list which includes the one or more desktop applications from among the plurality of applications stored in the storage. The manager 140 may classify the plurality of applications stored in the storage into a desktop application and a metro application. An installation location of a desktop application (for example, a file or older location of %programdata%WMicrosoftWwindowsWStart Menu folder) is different from that of a metro application. Accordingly, the manager 140 may classify the applications using the installation locations of the applications.

Also, a metro application includes a unique ID value in addition to a program name, whereas a desktop application does not include a unique ID value. Therefore, the manager 140 may determine whether an application is a desktop application or a metro application based on whether the application includes a unique ID value. The classifying operation may be performed according to a single criterion or may be performed by applying the above-described determining criteria complexly.

If classifying of the plurality of applications is completed through the above-described process, the manager 140 manages the applications classified as desktop applications as the first list.

If a new application is installed and it is determined that the new application is a desktop application, the manager 140 may add the new application to the first list. If a desktop application is deleted, the manager 140 may remove the deleted desktop application from the first list.

The manager 140 manages the second list which includes a desk application which has been already selected from among the desktop applications. If a desktop application to be located on the quick starter region is selected by the user, the manager 140 may manage the selected desktop application as the second list.

If the first list is displayed on the user interface 120 and if the user places one of the plurality of desktop applications displayed on the first list in the quick starter region by dragging or moving the desktop application, the manager 140 manages the dragged desktop application as the second list.

If a command to delete (or remove) one of the second icons (desktop applications of the second list) displayed on the quick starter region is received, the manager 140 may delete the desktop application corresponding to the second icon, which is instructed to be deleted, from the second list.

The manager 140 may arrange the desktop applications in the first list and/or the second list. The manager 140 may arrange the desktop applications of the first list in a predetermined order based on an installing time of each desktop application, whether the desktop application has been used recently, and a frequency of execution.

Also, the manager 140 may arrange the desktop applications of the second list in a predetermined order based on an installing time of each desktop application, whether the desktop application has been used recently, and a frequency of execution.

It is possible that a user may set a priority on how to arrange the desktop applications in the first list or the second list through a user interface. The manager 140 may arrange the desktop application according to the set priority. The priority may be higher, intermediate, and lower priorities. It is possible that one of the installing time of each desktop application, whether the desktop application has been used recently, and the frequency of execution may have the higher priority to be arranged on a top position of the list.

The manager 130 may group the plurality of desktop applications of the second list according to a predetermined category. For example, a plurality of document creating applications may be grouped into a single document creating group and a plural document creating group, and music reproducing applications and moving picture reproducing applications may be grouped into a multimedia group. Such a grouping operation may be performed by a user's selection or preference and may be performed automatically if the number of desktop applications of the second list is greater than or equal to a predetermined number. In the present exemplary embodiment, the plurality of applications are grouped according to a predetermined category. However, a plurality of applications that do not belong to the same category may be grouped into a single group by a user's selection.

The controller 150 controls the elements of the electronic apparatus 100. The controller 150 may control the manager 140 to manage the first list when a system is turned on or a new application is installed. If the mouse pointer is placed on a predetermined region by a user's manipulation or when a desktop of the operating system is displayed, the controller 150 may control the user interface 120 to display the quick starter region.

If the mouse pointer is placed on one of the icons of the quick starter region, the controller 150 may control the user interface 120 to change the size of the icon on which the mouse pointer is placed. If the mouse pointer is placed on the third icon, the controller 150 may control the user interface 120 to display the second icons of the plurality of desktop applications corresponding to the third icon in sequence.

If the mouse pointer selects the first icon, the controller 150 may control the user interface 120 to display the first list. If one of the applications of the first list is selected, the selected application is executed and then the executed application can be included in at least one of the second list and the third list. If the mouse pointer selects the second icon, the controller 150 may drive a desktop application corresponding to the selected second icon. Also, if the mouse pointer selects the third icon, the controller 150 may control the user interface 120 to collectively display icons of the plurality of desktop applications corresponding to the third icon.

As described above, the electronic apparatus 100 according to the present exemplary embodiment provides the quick starter region, which has the icon on the desktop application that the user has frequently used, to the user, and thus, the user can easily execute the desktop application. Also, the electronic apparatus 100 according to the present exemplary embodiment provides the list of desktop applications to the user, and thus, the user can easily execute the desktop application that the user has not frequently used.

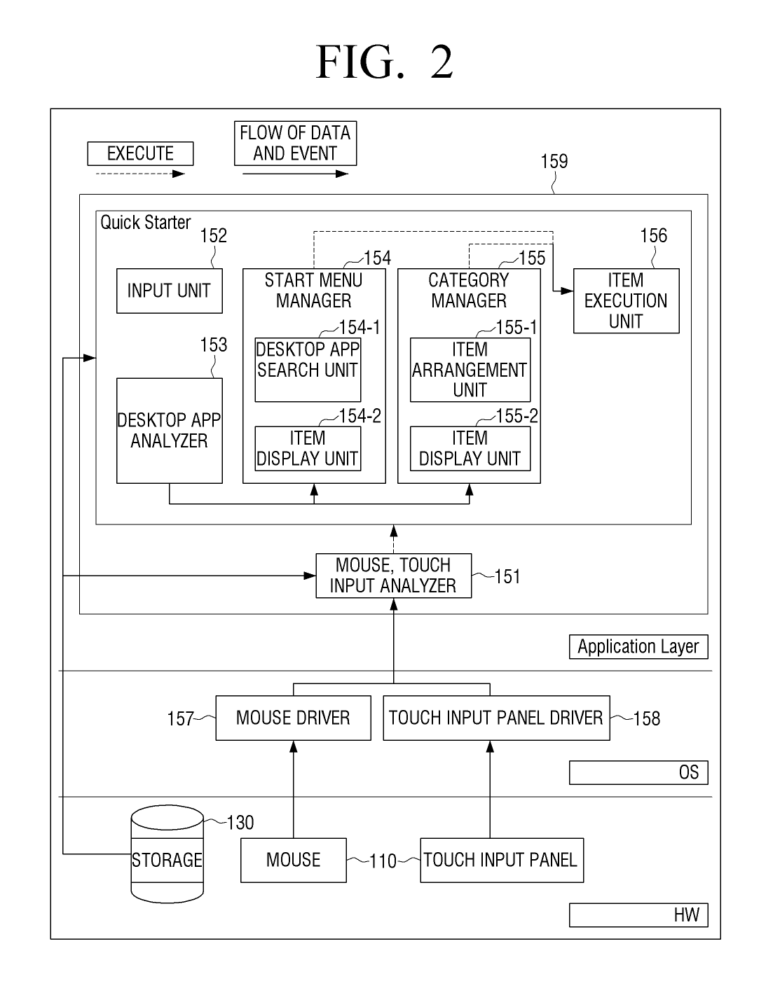

Although the manager 140 and the controller 150 are separate elements in FIG. 1, the function of the manager 140 and the function of the controller 150 may be realized by a single element according to a design or user preference. This exemplary embodiment will be explained below with reference to FIG. 2.

FIG. 2 is a block diagram illustrating the controller 150 of the electronic apparatus 100 of FIG. 1 according to an embodiment of the present general inventive concept.

Referring to FIG. 2, the controller 150 includes an application layer and an operating system (OS) layer.

The OS layer interfaces between hardware HW and an application OS and manages computer resources such as the storage 130 and the user interface 120. The OS layer may include a mouse driver 157 and a touch input panel driver 158.

The application layer is a layer on which an application driven on the OS is operated. Such an application layer includes the desktop application and the metro application described above.

The application layer may include a quick starter application 159 and a mouse/touch input analyzer 151 as illustrated in FIG. 2.

The mouse/touch input analyzer 151 provides location information of the mouse pointer and mouse click information to the quick starter application 159.

The quick starter application 159 is a desktop application that displays the quick starter region on a predetermined location when the mouse pointer is placed on a predetermined location or a screen of the desktop operating system is displayed. Therefore, the user can obtain the effect of the present disclosure simply by installing the quick starter application on an operating system of the electronic apparatus 100.

The quick starter application 159 includes an input unit 152, a desktop application analyzer 153, a start menu manager 154, a category manager 155, and an item execution unit 156.

The input unit 152 receives a command to drive the quick starter application. When the user clicks or touches a start menu of the quick starter application, a series of operations of displaying the quick starter region is performed.

The desktop application analyzer 153 analyzes each of the plurality of applications installed in the electronic apparatus 100 to determine whether the application is a desktop application or a metro application. Such an analyzing operation may be performed when the quick starter application is initially installed. If analyzing of the plurality of installed applications is completed, only a new application is analyzed when the new application is installed in the electronic apparatus 100.

The start menu manager 154 includes a desktop application search unit 154-1 and an item display unit 154-2.

The desktop application search unit 154-1 manages the application that is analyzed as a desktop application as the first list based on a result of analyzing of the desktop application analyzer 153.

The item display unit 153-2 stores icon information of each of the desktop application included in the first list. If the first icon is selected on the quick starter region, the item display unit 153-2 may display the first list using the first list and the icon information.

The category manager 155 includes an item arrangement unit 155-1 and an item display unit 155-2.

The item arrangement unit 155-1 may group the desktop applications included in the second list according to a predetermined category. The predetermined category may be developers of applications (for example, developer A, developer B, and developer C) or types of applications (game, multimedia, or A document creator). That is, the category may be a characteristic or a specific definition of the application

The item display unit 155-2 stores information on an icon grouped according to a category (for example, the third icon). The item display unit 155-2 displays the third icon which is displayed on the quick starter region, and, if the mouse pointer is placed on the third icon, displays the second icons of the plurality of desktop applications corresponding to the third icon in sequence. If the third icon is selected, the item display unit 155-2 may collectively display the second icons of the plurality of desktop applications corresponding to the third icon.

If one of the second icons displayed on the quick starter region is selected, the item execution unit 156 executes a desktop application corresponding to the selected second icon.

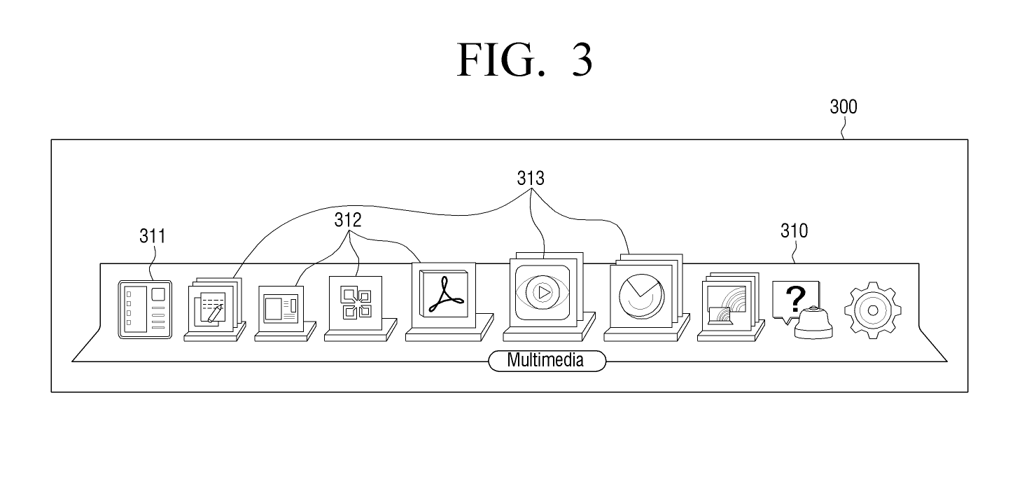

FIGS. 3 to 7 are views illustrating user interface windows 300, 400, 500, 600, 700, and 800, respectively, which may be displayed on the user interface 120 of the electronic apparatus 100 of FIG. 1.

Referring to FIG. 3, the user interface window 300 includes a quick starter region 310. The quick starter region 310 may be displayed when a user inputs a command to view a desktop or the mouse pointer is placed on a lower end (or an upper end, a right end, or a left end) of the user interface window 300.

The quick starter region 310 includes a first icon 311, one or more second icons 312, and one or more third icons 313.

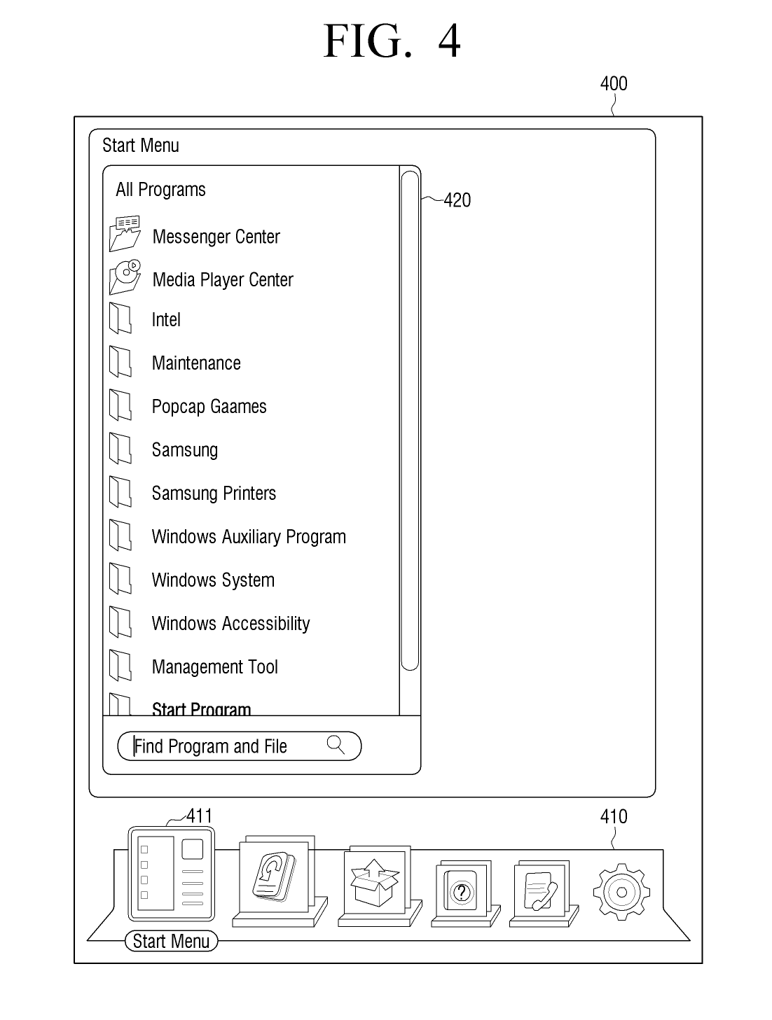

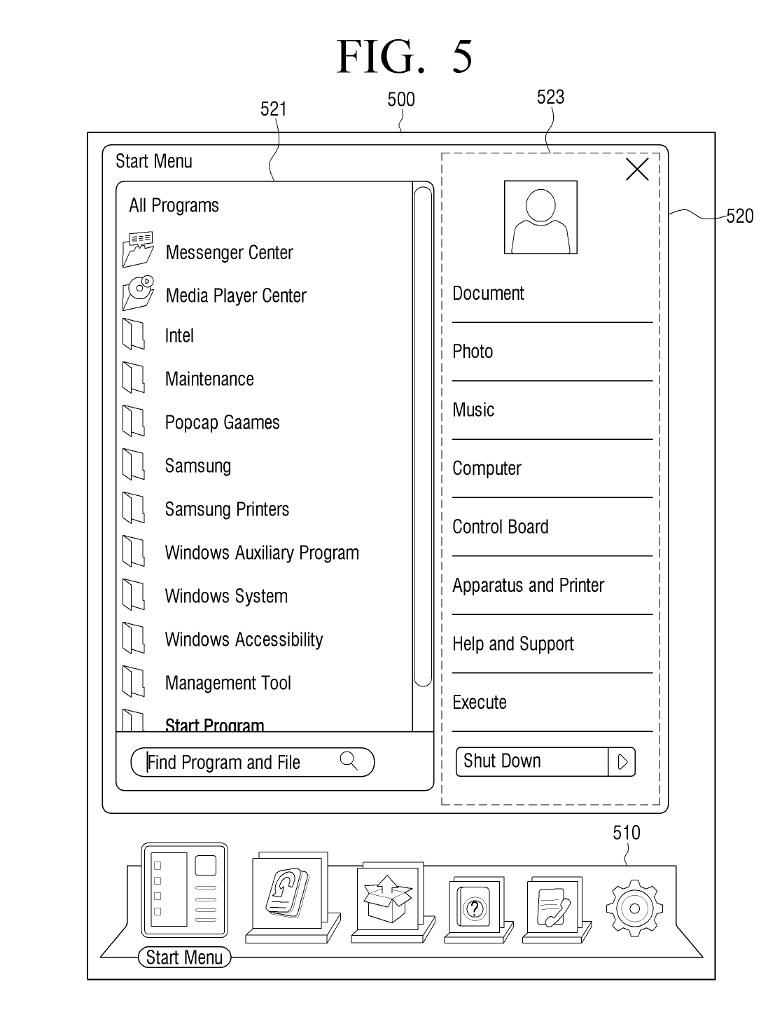

The first icon 311 is an icon to receive a first list display command. If the first icon 311 is selected, a first list may be displayed as illustrated in FIG. 4 or 5. This will be explained below with reference to FIGS. 4 and 5.

The second icons 312 correspond to desktop applications included in a second list. If one of the second icons 312 is selected, a desktop application corresponding to the selected second icon 312 is executed. Although the plurality of second icons are displayed in the drawing, if a single desktop application is included in the second list, a single second icon may be displayed on the quick starter region 310.

Each of the third icons 313 corresponds to a category of grouped desktop applications. The third icon 313 may be generated according to a user's generating command or may be automatically generated if the number of second icons is greater than or equal to a predetermined number.

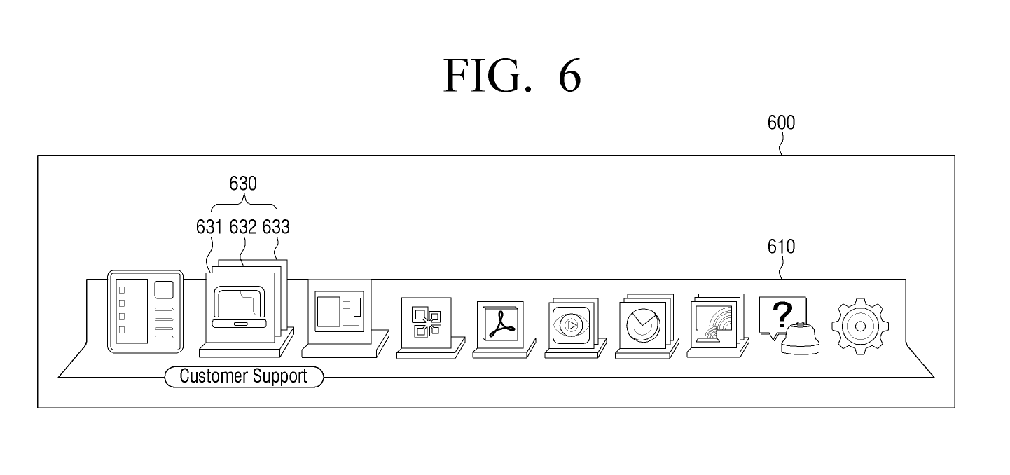

If the mouse pointer is placed on one of the third icons 313, the second icons of the plurality of desktop applications corresponding to the selected third icon may be displayed in sequence. As illustrated in FIG. 6, if the mouse pointer is placed on one of the one or more third icons 630, a second icon 631 corresponding to a first application in a category which is determined according to a predetermined condition is displayed among the icons 631, 632, and 633.

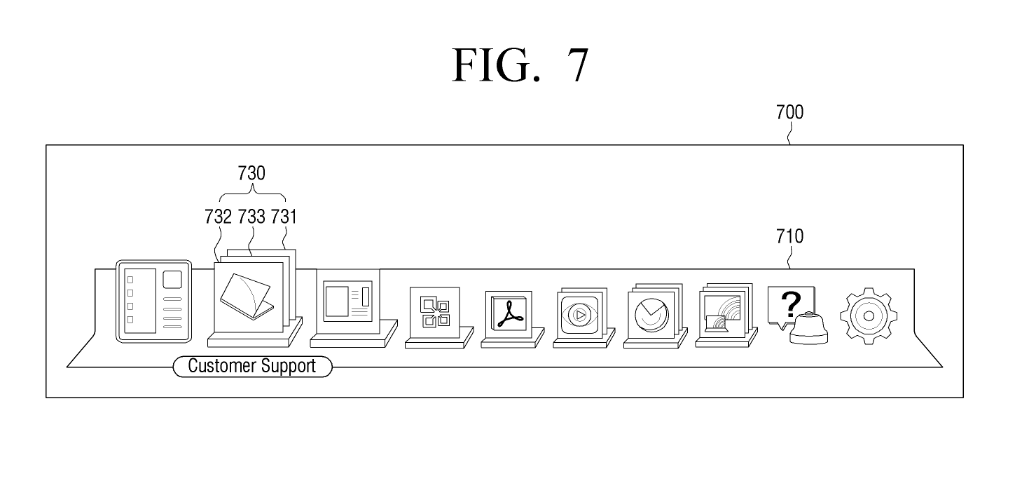

If a predetermined time (for example, 0.5 second or 1 second) elapses after the second icon 631 or 731 is placed on the location of the third icon 630, a second icon 632 or 732 corresponding to a second application in the category determined according to the predetermined condition is displayed among icons 631-633 or 731-733 as illustrated in FIGS. 6 and 7. Through the above-described process, the plurality of applications in the category may be displayed in sequence.

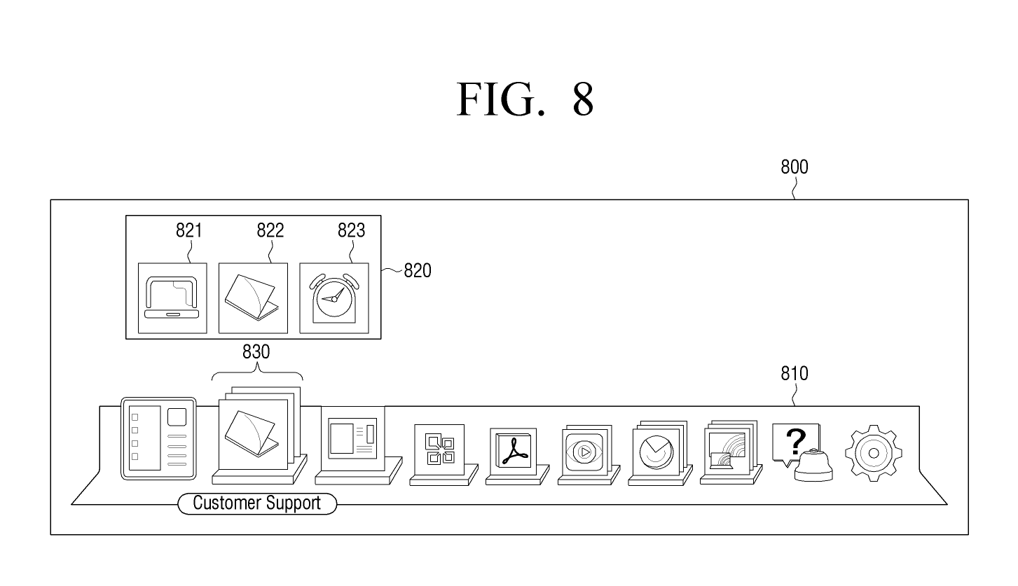

Also, as illustrated in FIG. 8, if a third icon 830 is selected in a region 810, second icons 821, 822, and 823 of the plurality of desktop applications corresponding to the third icon 830 may be collectively displayed on an upper region 820 of the third icon.

Referring to FIG. 4, the user interface window 400 includes a quick starter region 410 and a list region 420.

The quick starter region 410 may be the same as the quick starter region 310 of FIG. 3 and thus an overlapped explanation is omitted.

The list region 420 is displayed if the user selects a first icon 411 of the quick starter region 410, and displays a first list. The first list displays a list of desktop applications from among applications installed in the electronic apparatus 100. The list region 420 may arrange and display the desktop applications according to an installing time of each desktop application, whether the desktop application is included in a second list or not, and a frequency of execution.

The list region 420 may group the desktop applications according to a predetermined category (for example, a type of an application or an application developer). Also, the list region 420 may display a newly installed desktop application in a different color from the other desktop applications.

Although the list region 420 displays only the plurality of desktop applications in the illustrated example, the list region 420 may display the first list and simultaneously display a region to receive various control shortcut commands as shown in FIG. 5.

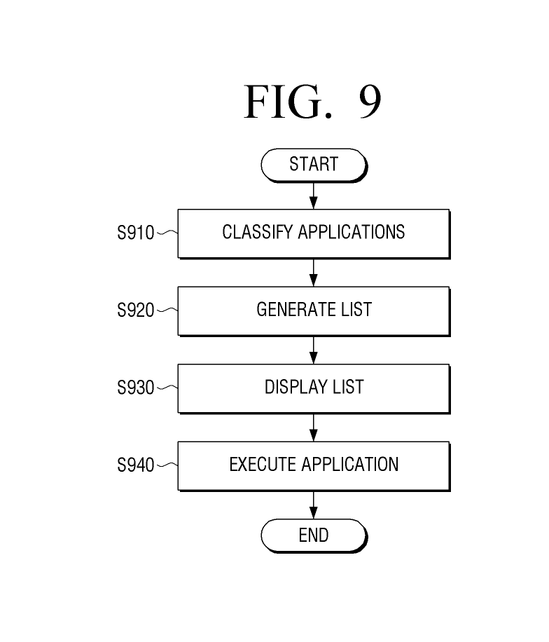

FIG. 9 is a flowchart illustrating a method of executing an application according to an exemplary embodiment of the present general inventive concept.

It is determined whether each of a plurality of pre-stored (or pre-installed) applications is a desktop application or a metro application at operation S910. Since an installation location of a desktop application is different from that of a metro application, the applications may be classified using the installation locations of the applications. Also, a metro application includes a unique ID value in addition to a program name, whereas a desktop application does not include a unique ID value. Therefore, the application is classified as a desktop application or a metro application based on whether the application includes a unique ID value or not.

A first list and a second list are managed at operation S920. When a controller classifies the plurality of applications, the application classified as the desktop application is managed as the first list. The managing recited herein includes generating an initial list and modifying the list in response to addition and deletion of an application after the list has been generated. The managing operation may be performed in response to an addition or deletion event of an application.

The second list including a desktop application which has been already selected from among the desktop applications is managed. When a desktop application to be located on the quick starter region is selected by the user, the selected desktop application is managed as the second list.

A first icon corresponding to the first list and a second icon corresponding to each of the desktop applications included in the second list are displayed at operation S930. The second icons may be arranged and displayed based on at least one of an installing time and a frequency of execution of the desktop application included in the second list. If the second icons are grouped according to a category, a third icon including the grouped second icons may be displayed along with the first icon and the second icon.

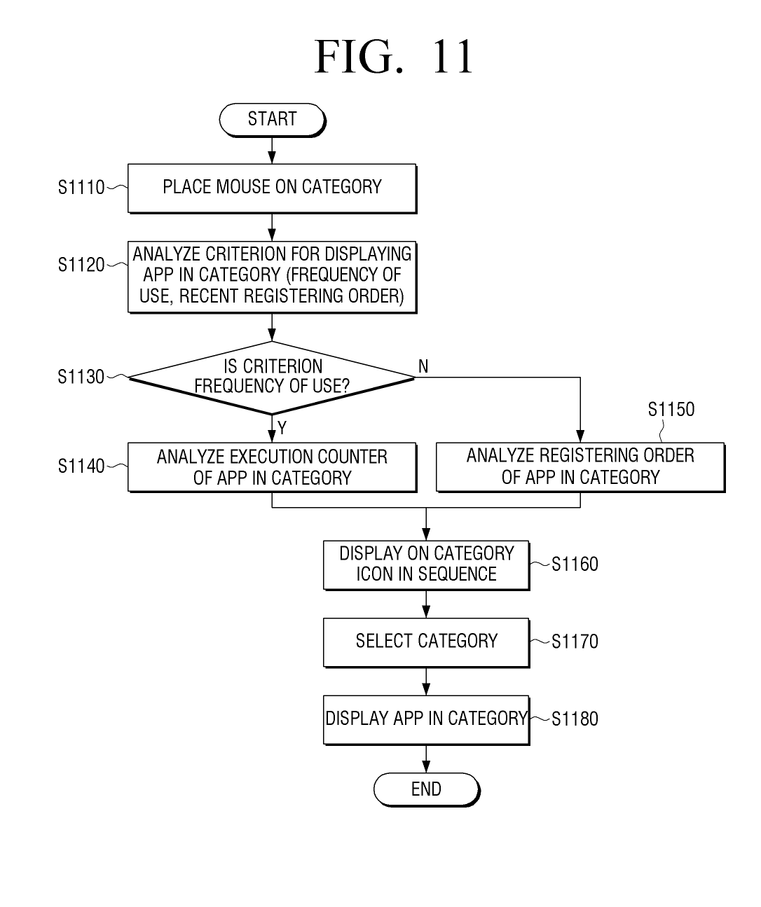

If one of the displayed second icons is selected, a desktop application corresponding to the selected icon is driven at operation S940. If the displayed first icon is selected, the first list may be displayed. If the displayed third icon is selected, the second icon of each of the desktop applications corresponding to the third icon may be displayed. The operation of displaying the third icon will be explained below with reference to FIG. 11.

Since the method for executing the application according to the exemplary embodiment as described above provides the quick starter region, which has the icon on the desktop application that the user has frequently used, to the user, the user can easily execute the desktop application. Also, since the method for executing the application according to the exemplary embodiment as described above provides the list of desktop applications to the user, the user can easily execute the desktop application that the user has not frequently used. The method for executing the application of FIG. 9 may be executed on the electronic apparatus having the configuration of FIG. 1 and may be executed in an electronic apparatus having other configurations.

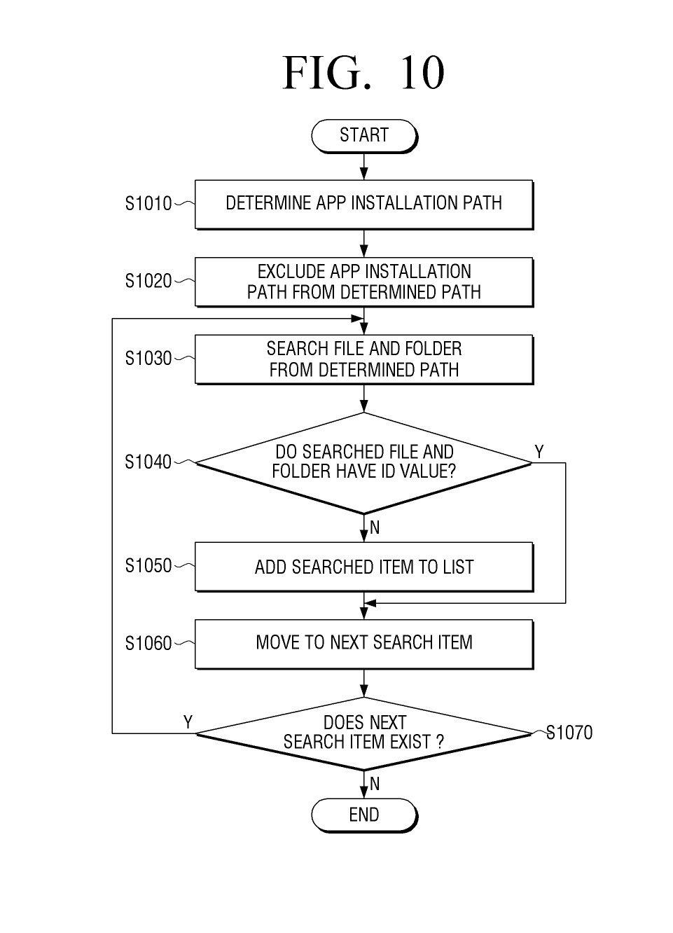

FIG. 10 is a flowchart illustrating an operation of classifying the applications in the method of FIG. 9 according to an embodiment of the present general inventive concept.

Referring to FIG. 10, a desktop application installation path is determined at operation S1010. When a desktop application and a metro application are installed, a folder storing the desktop application and a folder storing the metro application are different from each other. A location of the folder in which the desktop application is installed is determined as the application installation path.

A metro application installation path is excluded from the determined installation paths at operation S1020.

A file and a folder are searched from the determined path and an installed application is searched at operation S1030.

It is determined whether the searched application has a unique ID value in addition to a program name or not at operation S1040. Since the metro application displays a unique ID value in addition to a program name unlike the desktop application, it is verified whether the searched application is a desktop application or not based on whether the application has a unique ID value or not.

If it is determined that the application does not have a unique ID value at operation S1040-N, the searched application is added to the first list at operation S1050.

The operations of searching and determining are repeated with respect to all of the applications in the installation path at operation S1060 and 1070.

By performing the above-described operation, it is determined whether each of the plurality of applications installed in the electronic apparatus 100 is a metro application or a desktop application.

FIG. 11 is a flowchart to explain the operation of displaying in the method of FIG. 9 according to an embodiment of the present general inventive concept.

Referring to FIG. 11, if the user places the mouse pointer on the third icon (for example, a predetermined category) at operation S1110, a criterion to display the applications in the category is analyzed at operation S1120. An order in which the plurality of desktop applications included in the one category are arranged is determined.

If the criterion is a frequency of use as a result of the analyzing at operation S1130-Y, a frequency of use of each of the applications in the category is analyzed at operation S1140.

When the criterion is an application registering order at operation S1130-N, a registering order of each of the applications in the category is analyzed at operation S1150.

Based on a result of the analyzing, the second icons corresponding to the plurality of applications in the category may be displayed in sequence at operation S1160.

If the user selects the third icon at operation S1170, the second icons corresponding to the plurality of applications in the category corresponding to the third icon may be collectively displayed at operation S1180. The second icons corresponding to the applications of the category may be displayed in the vicinity of the third icon (for example, an upper region of the third icon).

In the displaying operation of FIG. 11, the order of displaying the applications in the category is determined. However, the operation of determining the order of displaying the applications in the category may be performed in advance. In this case, the second icons corresponding to the plurality of applications in the category corresponding to the third icon may be displayed in the pre-determined order.

Although the order of displaying is determined based on the registering order or the frequency of use in FIG. 11, the order of displaying may be determined based on a time at which the application is included in the second list and a time at which the application is used recently, besides the above-described criteria.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD or DVD-ROMs, hard disk, a Blue-ray disk, a USB, a memory card, and a ROM, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus, which has a first operation mode in which a desktop application is driven and a second operation mode in which a metro application is driven, the electronic apparatus comprising:
a storage to store a plurality of applications;
a manager to manage a first list to include one or more desktop applications from among the plurality of applications stored in the storage, and to manage a second list including one or more desktop applications that have been already selected from among the desktop applications;
a user interface to display a first icon which corresponds to the first list and one or more second icons which correspond to each desktop application included in the second list; and
a controller which, if one of the displayed second icons is selected, drives the desktop application corresponding to the selected icon.

2. The electronic apparatus as claimed in claim 1, wherein the manager classifies the plurality of applications stored in the storage into a desktop application and a metro application according to whether the application comprises a unique ID value or not, and manages an application which is classified as a desktop application as the first list.

3. The electronic apparatus as claimed in claim 1, wherein the manager manages an application which is stored in a pre-set folder from among the plurality of applications stored in the storage as the first list.

4. The electronic apparatus as claimed in claim 1, wherein the user interface arranges and displays the second icon based on at least one of an installing time and a frequency of execution of a desktop application corresponding to the second icon.

5. The electronic apparatus as claimed in claim 1, wherein, if a mouse pointer is placed on one of the plurality of icons, the user interface changes a size of the icon on which the mouse pointer is placed and displays the icon.

6. The electronic apparatus as claimed in claim 1, wherein, if the displayed first icon is selected, the user interface displays the first list.

7. The electronic apparatus as claimed in claim 6, wherein, if one desktop application is selected from the displayed first list, the controller drives the selected desktop application.

8. The electronic apparatus as claimed in claim 6, wherein, if one desktop application is selected from the displayed first list, the manager adds the selected desktop application to the second list.

9. The electronic apparatus as claimed in claim 6, wherein, if the displayed first icon is selected, the user interface arranges and displays the plurality of desktop applications included in the first list based on at least one of an installing time, whether the desktop application is included in the second list or not, and a frequency of execution.

10. The electronic apparatus as claimed in claim 1, wherein:
the manager groups the already selected desktop applications according to a predetermined category; and
the user interface displays a third icon corresponding to the grouped desktop applications along with the first icon and the second icon.

11. The electronic apparatus as claimed in claim 10, wherein, if a mouse pointer is placed on the third icon, the user interface displays a plurality of second icons corresponding to the third icon in sequence.

12. The electronic apparatus as claimed in claim 10, wherein, if a number of desktop applications included in the second list is greater than a predetermined number, the manager groups the already selected desktop applications according to the predetermined category.

13. The electronic apparatus as claimed in claim 1, wherein, only if a mouse pointer is placed on a predetermined location, the controller controls the user interface to display the first icon and the second icon on a predetermined location.

14. A method of executing an application of an electronic apparatus, which has a first operation mode in which a desktop application is driven and a second operation mode in which a metro application is driven, the method comprising:
managing a first list including one or more desktop applications from among a plurality of pre-stored applications, and managing a second list to include one or more desktop applications that have been already selected from among the desktop applications;
displaying a first icon which corresponds to the first list and a second icon which corresponds to each desktop application included in the second list;
selecting one of the displayed second icons; and
driving a desktop application corresponding to the selected icon.

15. The method as claimed in claim 14, wherein the managing comprises:
classifying the plurality of applications stored in a storage into the desktop application and the metro application according to whether the application comprises a unique ID value or not; and
managing an application which is classified as a desktop application as the first list.

16. The method as claimed in claim 14, wherein the managing comprises managing an application which is stored in a pre-set folder from among the plurality of applications stored in the storage as the first list.

17. The method as claimed in claim 14, further comprising:
if the displayed first icon is selected, displaying the first list.

18. The method as claimed in claim 14, wherein:
the managing comprises grouping the already selected desktop applications according to a predetermined category; and
the displaying comprises displaying a third icon corresponding to the grouped desktop applications along with the first icon and the second icon.

19. The method as claimed in claim 18, wherein the displaying comprises, if a mouse pointer is placed on the third icon, displaying a plurality of second icons corresponding to the third icon in sequence.

20. A non-transitory computer readable recording medium to contain computer-readable codes as a program to execute the method of claim 14.

21. An electronic apparatus, which has a first operation mode in which a desktop application is driven and a second operation mode in which a metro application is driven, and which includes a plurality of applications, the electronic apparatus comprising:
a manager to form a first list to include one or more desktop applications from among the plurality of applications, and to form a second list including one or more of the desktop applications that have been already selected from among the desktop applications; and
a user interface having a screen to display a first icon which corresponds to the first list and one or more second icons which correspond to each desktop application included in the second list.

22. The electronic apparatus of claim 21, wherein the manager forms a third icon corresponding to a third list including one or more of the one or more desktop applications of the second list which have a same category.

23. The electronic apparatus of claim 21, wherein the manager forms a third icon corresponding to a third list including one or more of the one or more desktop applications of the second list, and the user interface displays the one or more desktop applications of the second list or the one or more desktop applications of the third list according to a priority.

24. The electronic apparatus of claim 21, wherein the user interface displays the first icon and the second icon according to an input to select at least one of the first icon and the second icon, and prevent the first icon and the second icon from being displayed on the screen when an operating system is performed and displayed on the screen until the input.

25. The electronic apparatus of claim 21, wherein the user interface displays the first icon and the second icon according to an operation of a QWERTY key board including a mouse with respect to the screen of the user interface.
